(19) United States
(12) Patent Application Publication
(10) Pub. No.: US 2008/0311837 A1
(43) Pub. Date: Dec. 18, 2008

(54) PREVENTIVE MAINTENANCE HOOD

(75) Inventors: Ching-Cheng Hsu, Miaoli County (TW); Fu-Tian Chen, Taichung County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/761,578

(22) Filed: Jun. 12, 2007

(51) Int. Cl. B08B 15/02

(52) U.S. Cl. 454/65; 454/56

(57) ABSTRACT

The present invention provides a preventive maintenance hood suitable for a reaction chamber of a semiconductor machine and connected to an exhaust pipe. The preventive maintenance hood includes a hood body, an air curtain forming apparatus, and an exhaust pipe connector. The hood body includes a first opening and a second opening. The first opening is located at a bottom of the hood body and adapted to cover an exit of the reaction chamber, while the second opening is located on a sidewall of the hood body. The air curtain forming apparatus is disposed on the hood body and located at an edge of the second opening. The exhaust pipe connector is mounted on the hood body and connected to the exhaust pipe.

### BACKGROUND OF THE INVENTION

1. Field of the Invention

The present invention relates to a maintenance apparatus of a semiconductor machine, and more particularly to a preventive maintenance hood of a semiconductor machine.

2. Description of Related Art

In the fabrication process of the semiconductor, deposition chambers used in a chemical vapor deposition (CVD) process are generally divided into various types, such as a horizontal type, a vertical type and a barrel type. Taking the vertical type deposition chamber for example, a reactant gas enters the chamber through a bottom of the chamber, reacts with a wafer inside the chamber, and then deposits a thin film on the wafer. However, the reactant gas deposits a thin film not only on the surface of the wafer but also on the inner wall of the chamber. Since the composition of the thin film to be deposited in each deposition process is different, the deposition chamber must be cleaned after the completion of a process so as to prevent the compound deposited on the chamber wall from causing negative effect on the next CVD process.

FIG. 1 illustrates a schematic view of a conventional preventive maintenance hood. FIG. 2 illustrates a schematic view of another conventional preventive maintenance hood. FIG. 3 illustrates a schematic view of yet another conventional preventive maintenance hood.

Referring to FIG. 1, when a cleaning process is performed in a deposition chamber 102 of a deposition machine 100, a preventive maintenance hood 104 is utilized to cover the deposition chamber 102 so that hazardous substances and toxic gases generated during the cleaning process of the deposition chamber 102 do not dissipate everywhere.

When operators utilize the preventive maintenance hood 104 to clean the deposition chamber 102, they put their hands through a plastic curtain 108 having a cross-shaped opening 106 thereon to do the cleaning. Although the hazardous substance and the toxic gases can be sucked to an outer portion of the preventive maintenance hood 104 through an exhaust pipe 112 connected with an exhaust pipe connector 110, during the cleaning process, the hazardous substance and the toxic gases still tend to dissipate through the cross-shaped opening 106 on the plastic curtain 108. When the plastic curtain 108 is easily deteriorated by contacting chemicals to be torn or worn, the pollution becomes even more serious. Moreover, the design of the plastic curtain 108 hampers the movement of operators during their operation, which in turn renders the cleaning process inefficient.

In the prior art, many different types of preventive maintenance hoods are presented as solutions to the problem of dissipated hazardous substances and toxic gases during a cleaning process.

Referring to FIG. 2, a conventional preventive maintenance hood is that, when utilizing a preventive maintenance hood 200, an operator puts his or her hand through an opening 204 on the lid board 202 to proceed with a cleaning process. An exhaust pipe (not illustrated) connected with an exhaust pipe connector 206 is also used to suck the hazardous substance and the toxic gases to an outer portion of the preventive maintenance hood 200. However, the opening 204 on the lid board 202 is overly large that the hazardous substance and the toxic gas dissipate from the opening 204. From another aspect, the lid board 202 is designed as such that it is difficult for operators to do the cleaning.

Referring to FIG. 3, another conventional preventive maintenance hood is that, when utilizing a preventive maintenance hood 300, an operator puts his or her hand through an opening under a top lid 302 to proceed with a cleaning process. An exhaust pipe 306 connected with an exhaust pipe connector 304 is used to suck the hazardous substance and the toxic gas to an outer portion of the preventive maintenance hood 300. Nevertheless, the opening under the top lid 302 is overly small that it is difficult for operators to do to the cleaning.

### SUMMARY OF THE INVENTION

In view of the aforementioned, the present invention is directed to a preventive maintenance hood which effectively prevents hazardous substances and toxic gases from dissipating. The invention further provides a preventive maintenance hood which allows operators to perform a cleaning process easily.

The invention presents a preventive maintenance hood suitable for a reaction chamber of a semiconductor machine and connected to an exhaust pipe. The preventive maintenance hood includes a hood body, an air curtain forming apparatus and an exhaust pipe connector. The hood body includes a first opening and a second opening. The first opening is located at a bottom of the hood body and adapted to cover an exit of the reaction chamber, while the second opening is located on a sidewall of the hood body. The air curtain forming apparatus is disposed on the hood body and located at an edge of the second opening. The exhaust pipe connector is mounted on the hood body and connected to the exhaust pipe.

According to one embodiment of the invention, in the preventive maintenance hood, a hood body surface whereon the air curtain forming apparatus is disposed has a tilt angle. According to one embodiment of the invention, in the preventive maintenance hood, the air curtain forming apparatus forms an air curtain with an emission direction, which makes the exit of the reaction chamber is enclosed by the air curtain and the hood body.

According to one embodiment of the invention, in the preventive maintenance hood, the emission direction of the air curtain forming apparatus is parallel to a hood body surface whereon the air curtain forming apparatus is disposed. According to one embodiment of the invention, in the preventive maintenance hood, the emission direction of the air curtain forming apparatus is a direction by which the air curtain is formed inside the hood body.

In one embodiment of the invention, in the preventive maintenance hood, the air curtain forming apparatus further includes a dismantling device.

In one embodiment of the invention, in the preventive maintenance hood, the disposition of the air curtain forming apparatus is selectively to attach inside or outside the hood body.

According to one embodiment of the invention, the preventive maintenance hood further includes a receiving port and a storage bag. The receiving port is located on another sidewall of the hood body. The storage bag is disposed outside the hood body and seals the receiving port.

According to one embodiment of the invention, the preventive maintenance hood further includes a soft pad disposed at the bottom of the hood body.

According to one embodiment of the invention, the preventive maintenance hood further includes a pair of handles disposed on the hood body.

The invention presents another preventive maintenance hood suitable for a reaction chamber of a semiconductor machine and connected to an exhaust pipe. The preventive maintenance hood includes a hood body, an air curtain forming apparatus and an exhaust pipe connector. The hood body is a hexahedron including a first opening and a second opening. The first opening is located at a bottom of the hood body and adapted to cover an exit of the reaction chamber, while the second opening is located on a first sidewall of the hood body. The air curtain forming apparatus is disposed on the first sidewall of the hood body and located at an edge of the second opening. The exhaust pipe connector is mounted on the hood body and connected to the exhaust pipe.

According to another embodiment of the invention, in the preventive maintenance hood, the first sidewall whereon the air curtain forming apparatus is disposed has a tilt angle.

According to another embodiment of the invention, in the preventive maintenance hood, the air curtain forming apparatus forms an air curtain along an emission direction, which makes the exit of the reaction chamber is enclosed by the air curtain and the hood body.

According to another embodiment of the invention, in the preventive maintenance hood, the emission direction of the air curtain forming apparatus is parallel to the first sidewall whereon the air curtain forming apparatus is disposed.

According to another embodiment of the invention, in the preventive maintenance hood, the emission direction of the air curtain forming apparatus is a direction by which the air curtain is formed inside the hood body.

According to another embodiment of the invention, in the preventive maintenance hood, the air curtain forming apparatus further includes a dismantling device.

According to another embodiment of the invention, in the preventive maintenance hood, the disposition of the air curtain forming apparatus is selectively to attach inside or outside the hood body.

According to another embodiment of the invention, the preventive maintenance hood further includes a receiving port and a storage bag. The receiving port is located on a second sidewall of the hood body. The storage bag is disposed outside the hood body and seals the receiving port.

According to another embodiment of the invention, the preventive maintenance hood further includes a soft pad disposed at the bottom of the hood body.

According to another embodiment of the invention, the preventive maintenance hood further includes a pair of handles disposed on the hood body.

As broadly described above, the air curtain forming apparatus of the preventive maintenance hood provided in the present invention is utilized to form the air curtain and thus an enclosed environment in the hood body. As a result, hazardous substances and toxic gases can be effectively prevented from dissipating outwardly. Furthermore, operators can perform the cleaning process easily through the air curtain and thus improving work efficiency. In addition, when the sidewall of the air curtain forming apparatus is inclined with a tilt angle, the room for operators to move around is enlarged and thereby facilitating the cleaning process.

If the air curtain forming apparatus of the preventive maintenance hood has a dismantling device, the air curtain forming apparatus can be dismantled at will and utilized repetitively and thereby reducing the cost of purchasing new apparatuses.

When a storage bag is disposed on the preventive maintenance hood, cleaning tools can be directly placed inside the storage bag after use. Hence, when the cleaning tools are taken out from the storage bag, they are not directly exposed to the environment outside the hood body, which prevents the hazardous substance remaining on the cleaning tools and the toxic gas from polluting the environment.

With the soft pad disposed at the bottom of the preventive maintenance hood, it can reduce damage to the preventive maintenance hood caused by bumping and thereby extending the life span of the preventive maintenance hood.

If handles are disposed on the preventive maintenance hood, they would be useful when operators need to move the preventive maintenance hood.

In order to the make the aforementioned and other objects, features and advantages of the present invention more comprehensible, preferred embodiments accompanied with figures are described in detail below.

### BRIEF DESCRIPTION OF THE DRAWINGS

FIG. 1 illustrates a schematic view of a conventional preventive maintenance hood.

FIG. 2 illustrates a schematic view of another conventional preventive maintenance hood.

FIG. 3 illustrates a schematic view of yet another conventional preventive maintenance hood.

FIG. 4 illustrates a schematic view of a preventive maintenance hood according to one embodiment of the present invention.

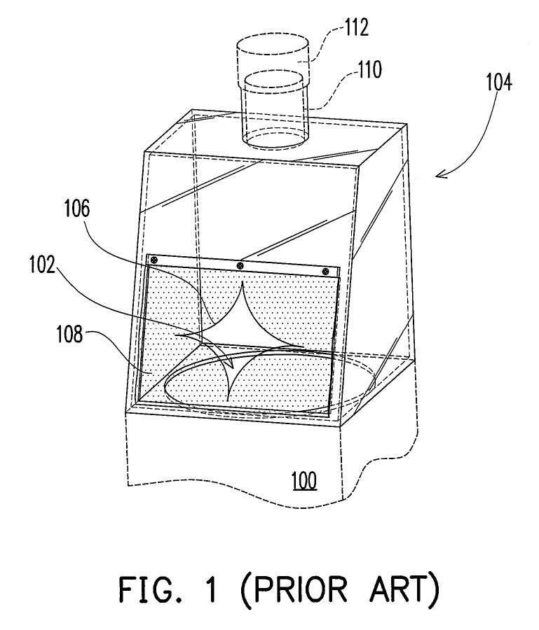

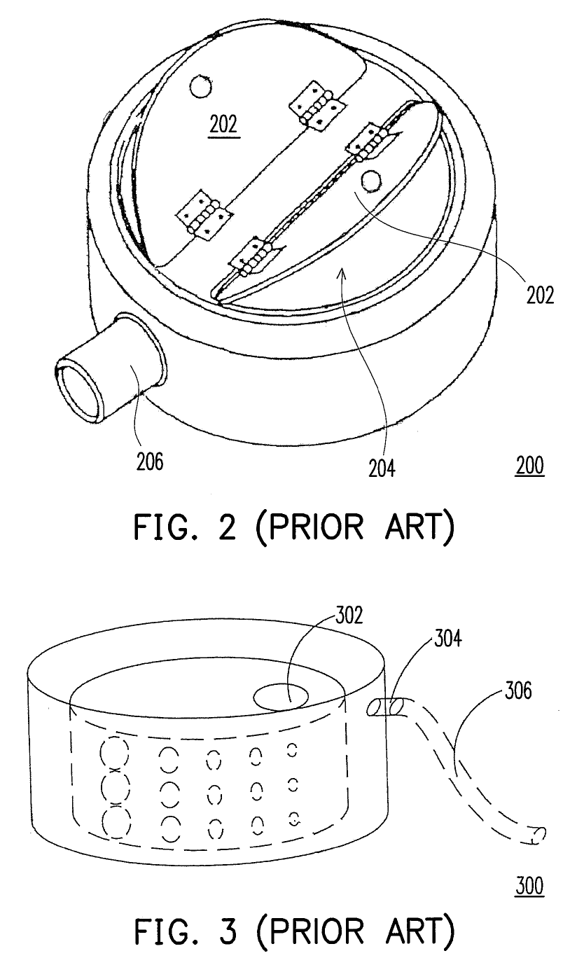

### DESCRIPTION OF EMBODIMENTS

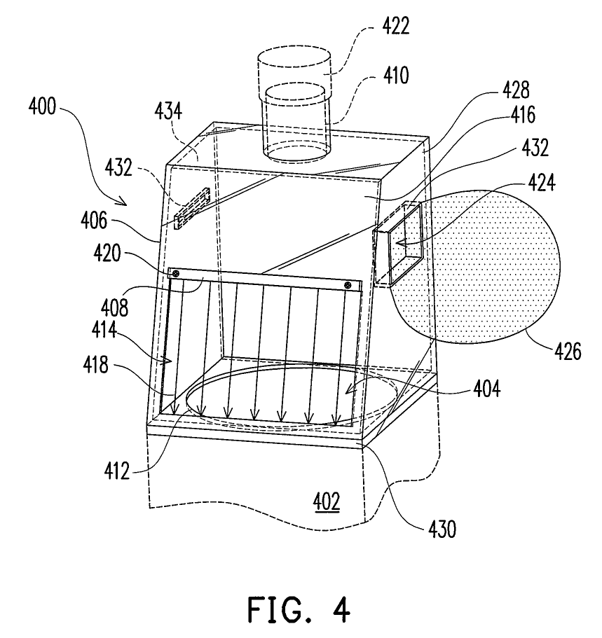

FIG. 4 illustrates a schematic view of a preventive maintenance hood according to one embodiment of the present invention.

Referring to FIG. 4, a preventive maintenance hood 400 is suitable for a reaction chamber 404 of a semiconductor machine 402. A preventive maintenance hood 400 may be used for performing a cleaning process in the reaction chamber 404, for example. The semiconductor machine 402 may be an etching machine or a chemical vapor deposition (CVD) machine.

The preventive maintenance hood 400 includes a hood body 406, an air curtain forming apparatus 408 and an exhaust pipe connector 410. In the present embodiment, the shape of the hood body 406 is hexahedral as an example to be described in the following. However, persons ordinarily skilled in the art may adjust the shape of the hood body 406 to meet the requirements of actual needs.

The hood body 406 includes an opening 412 and an opening 414. The opening 412 is located at a bottom of the hood body 406 and adapted to cover an exit of the reaction chamber 404, while the opening 414 is located on the sidewall 416 of the hood body 406. The material of the hood body 406 may be a plastic, such as acrylic. The sidewall 416 whereon the air curtain forming apparatus 408 is disposed has a tilt angle, which allows larger room over the sidewall 416 of the hood body 406 for operators to move around and thereby facilitating the cleaning process.

The air curtain forming apparatus 408 is disposed on the sidewall 416 of the hood body 406 and located at an edge of the opening 414. The air curtain forming apparatus 408 may be selectively to attach outside or inside the hood body 406. In the present embodiment, the air curtain forming apparatus 408 is designated to be disposed outside the hood body 406 as an example for the subsequent description. The material of the air curtain forming apparatus 408 may be a metal, for example. The air curtain forming apparatus 408 may form an air curtain with an emission direction 418, and then the exit of the reaction chamber 404 is enclosed by the air curtain and the hood body 406. The emission direction 418 of the air curtain forming apparatus 408 may be parallel to the sidewall 416 whereon the air curtain forming apparatus 408 is disposed. It should be noted that the emission direction 418 of the air curtain forming apparatus 408 is not necessarily parallel to the sidewall 416 whereon the air curtain forming apparatus 408 is disposed as long as the air curtain and the hood body 406 can form an enclosed environment inside the hood body 406. For example, in another embodiment, the emission direction 418 of the air curtain forming apparatus 408 may face a direction by which the air curtain is formed inside the hood body 406.

Besides, the air curtain forming apparatus 408 further includes a dismantling device 420 for dismantling the air curtain forming apparatus 408 at will. Therefore, the air curtain forming apparatus 408 can be utilized repetitively so as to lower the cost spent in purchasing new apparatuses. The dismantling device 420 may be screws, for example.

An exhaust pipe connector 410 is mounted on the top of the hood body and connected to an exhaust pipe 422 so that hazardous substances and toxic gases in the preventive maintenance hood 400 are sucked to a gas purifying system. The exhaust pipe connector 410 and the hood body 406 may be integrally formed. The exhaust pipe connector 410 and the hood body 406 may also be independently formed and then assembled together.

Additionally, the preventive maintenance hood 400 may further include an receiving port 424 and a storage bag 426. The receiving port 424 is located on a sidewall 428 of the hood body 406. The storage bag 426 is disposed outside the hood body 406 and seals the receiving port 424. The storage bag 426 may be a plastic bag. If the preventive maintenance hood 400 has the storage bag 426, cleaning tools can be directly placed in the storage bag 426, which is sealed afterwards, so that the cleaning tools are not directly exposed to the environment outside the preventive maintenance hood 400 and thus preventing the hazardous substance remaining on the cleaning tools and the toxic gas from polluting the environment. It should be noted that no specific limitation is imposed on the position of the receiving port 424 as long as the position thereof allows operators to easily put away the cleaning tools in the storage bag 426.

Furthermore, the preventive maintenance hood 400 further includes a soft pad 430. The soft pad 430 is disposed at the bottom of the hood body 406 and can be used to avoid damage to the preventive maintenance hood 400 caused by bumping and thus extending the life span of the preventive maintenance hood 400.

In another aspect, the preventive maintenance hood 400 further includes a pair of handles 432 disposed on the hood body 406 and useful for operators to move the preventive maintenance hood 400. The handles 432 can be disposed in corresponding positions on the two sides of the hood body 406, such as on a sidewall 428 and a sidewall 434. Wherein, the handle 432 located on the sidewall 428 is formed by broadening the top edge of the receiving port 424.

As broadly described above, in the preventive maintenance hood 400 provided in the present invention, the air curtain forming apparatus 408 is utilized to form the air curtain, which along with the hood body 406 constitute an enclosed environment inside the hood body 406 and thus preventing the hazardous substance and the toxic gas from dissipating. Additionally, since operators can perform a cleaning process easily through the air curtain, work efficiency can be thus improved.

In summary, the present invention has at least the following advantages:

1. The preventive maintenance hood provided in the invention effectively prevents the hazardous substance and the toxic gas from dissipating.

2. With the preventive maintenance hood presented by the invention, operators can proceed with a cleaning process easily and thereby improving work efficiency.

3. In the preventive maintenance hood provided in the invention, the air curtain forming apparatus can be utilized repetitively so as to lower the cost of purchasing new apparatuses.

4. The storage bag of the preventive maintenance hood of the invention can contain the cleaning tools so that the hazardous substance remaining on the cleaning tools and the toxic gas are prevented from polluting the environment.

5. The soft pad of the preventive maintenance hood of the invention can avoid damage to the preventive maintenance hood caused by bumping and thus extending the life span of the preventive maintenance hood.

6. The handles of the preventive maintenance hood provided by the invention are helpful to operators when moving the preventive maintenance hood.

1. A preventive maintenance hood disposed on a reaction chamber of a semiconductor machine and connected to an exhaust pipe, comprising:
a hood body including a first opening and a second opening, the first opening located at a bottom of the hood body and covering an exit of the reaction chamber, the second opening located on a sidewall of the hood body;
an air curtain forming apparatus disposed on the hood body and located at an edge of the second opening; and
an exhaust pipe connector mounted on the hood body and connected to the exhaust pipe.

2. The preventive maintenance hood of claim 1, wherein a hood body surface whereon the air curtain forming apparatus is disposed has a tilt angle.

3. The preventive maintenance hood of claim 1, wherein the air curtain forming apparatus forms an air curtain with an emission direction that makes the exit of the reaction chamber enclosed by the air curtain and the hood body.

4. The preventive maintenance hood of claim 3, wherein the emission direction of the air curtain forming apparatus is parallel to a hood body surface whereon the air curtain forming apparatus is disposed.

5. The preventive maintenance hood of claim 3, wherein the emission direction of the air curtain forming apparatus comprises a direction by which the air curtain is formed inside the hood body.

6. The preventive maintenance hood of claim 1, wherein the air curtain forming apparatus further comprises a dismantling device.

7. The preventive maintenance hood of claim 1, wherein disposition of the air curtain forming apparatus is made to selectively attach inside or outside the hood body.

8. The preventive maintenance hood of claim 1, further comprising:
a receiving port located on another sidewall of the hood body; and
a storage bag disposed outside the hood body and sealing the receiving port.

9. The preventive maintenance hood of claim 1, further comprising a soft pad disposed at the bottom of the hood body.

10. The preventive maintenance hood of claim 1, further comprising a pair of handles disposed on the hood body.

11. A preventive maintenance hood disposed on a reaction chamber of a semiconductor machine and connected to an exhaust pipe, comprising:
a hood body being a hexahedron including a first opening and a second opening, the first opening located at a bottom of the hood body and covering an exit of the reaction chamber, the second opening located on a first sidewall of the hood body;
an air curtain forming apparatus disposed on the first sidewall of the hood body and located at an edge of the second opening; and
an exhaust pipe connector mounted on the hood body and connected to the exhaust pipe.

12. The preventive maintenance hood of claim 11, wherein the first sidewall whereon the air curtain forming apparatus is disposed has a tilt angle.

13. The preventive maintenance hood of claim 11, wherein the air curtain forming apparatus forms an air curtain with an emission direction that makes the exit of the reaction chamber thereby enclosed by the air curtain and the hood body.

14. The preventive maintenance hood of claim 13, wherein the emission direction of the air curtain forming apparatus is parallel to the first sidewall whereon the air curtain forming apparatus is disposed.

15. The preventive maintenance hood of claim 13, wherein the emission direction of the air curtain forming apparatus comprises a direction by which the air curtain is formed inside the hood body.

16. The preventive maintenance hood of claim 11, wherein the air curtain forming apparatus further comprises a dismantling device.

17. The preventive maintenance hood of claim 11, wherein the disposition of the air curtain forming apparatus is made to selectively attach inside or the outside the hood body.

18. The preventive maintenance hood of claim 11, further comprising:
a receiving port located on a second sidewall of the hood body; and
a storage bag disposed outside the hood body and sealing the receiving port.

19. The preventive maintenance hood of claim 11, further comprising a soft pad disposed at the bottom of the hood body.

20. The preventive maintenance hood of claim 11, further comprising a pair of handles disposed on the hood body.

21. A preventive maintenance system, comprising the preventive maintenance hood of claim 1, the preventive maintenance hood being disposed on a reaction chamber of a semiconductor machine and connected to an exhaust pipe.

22. A preventive maintenance system, comprising the preventive maintenance hood of claim 11, the preventive maintenance hood being disposed on a reaction chamber of a semiconductor machine and connected to an exhaust pipe.

23. A preventive maintenance system, comprising:
a semiconductor machine, comprising a reaction chamber;
a preventive maintenance hood, disposed on the reaction chamber and comprising:
a hood body including a first opening and a second opening, the first opening located at a bottom of the hood body and covering an exit of the reaction chamber, the second opening located on a sidewall of the hood body;
an air curtain forming apparatus disposed on the hood body and located at an edge of the second opening; and
an exhaust pipe connector mounted on the hood body; and
an exhaust pipe, connected to the exhaust pipe connector, wherein the preventive maintenance hood is switched on when the reaction chamber is being cleaned.

24. The preventive maintenance system of claim 23, wherein a hood body surface whereon the air curtain forming apparatus is disposed has a tilt angle.

25. The preventive maintenance system of claim 23, wherein the air curtain forming apparatus forms an air curtain with an emission direction that makes the exit of the reaction chamber enclosed by the air curtain and the hood body.

26. The preventive maintenance system of claim 25, wherein the emission direction of the air curtain forming apparatus is parallel to a hood body surface whereon the air curtain forming apparatus is disposed.

27. The preventive maintenance system of claim 25, wherein the emission direction of the air curtain forming apparatus comprises a direction by which the air curtain is formed inside the hood body.

28. The preventive maintenance system of claim 23, wherein the air curtain forming apparatus further comprises a dismantling device.

29. The preventive maintenance system of claim 23, wherein disposition of the air curtain forming apparatus is made to selectively attach inside or outside the hood body.

30. The preventive maintenance system of claim 23, the preventive maintenance hood further comprising:
a receiving port located on another sidewall of the hood body; and
a storage bag disposed outside the hood body and sealing the receiving port.

31. The preventive maintenance system of claim 23, the preventive maintenance hood further comprising a soft pad disposed at the bottom of the hood body.

32. The preventive maintenance system of claim 23, the preventive maintenance hood further comprising a pair of handles disposed on the hood body.

33. A preventive maintenance system, comprising:
a semiconductor machine, comprising a reaction chamber;
a preventive maintenance hood, disposed on the reaction chamber and comprising:
a hood body being a hexahedron including a first opening and a second opening, the first opening located at a bottom of the hood body and covering an exit of the reaction chamber, the second opening located on a first sidewall of the hood body;
an air curtain forming apparatus disposed on the first sidewall of the hood body and located at an edge of the second opening; and
an exhaust pipe connector mounted on the hood body; and
an exhaust pipe, connected to the exhaust pipe connector, wherein the preventive maintenance hood is switched on when the reaction chamber is being cleaned.

34. The preventive maintenance system of claim 33, wherein the first sidewall whereon the air curtain forming apparatus is disposed has a tilt angle.

35. The preventive maintenance system of claim 33, wherein the air curtain forming apparatus forms an air curtain with an emission direction that makes the exit of the reaction chamber thereby enclosed by the air curtain and the hood body.

36. The preventive maintenance system of claim 35, wherein the emission direction of the air curtain forming apparatus is parallel to the first sidewall whereon the air curtain forming apparatus is disposed.

37. The preventive maintenance system of claim 35, wherein the emission direction of the air curtain forming apparatus comprises a direction by which the air curtain is formed inside the hood body.

38. The preventive maintenance system of claim 33, wherein the air curtain forming apparatus further comprises a dismantling device.

39. The preventive maintenance system of claim 33, wherein the disposition of the air curtain forming apparatus is made to selectively attach inside or the outside the hood body.

40. The preventive maintenance system of claim 33, the preventive maintenance hood further comprising:
a receiving port located on a second sidewall of the hood body; and
a storage bag disposed outside the hood body and sealing the receiving port.

41. The preventive maintenance system of claim 33, the preventive maintenance hood further comprising a soft pad disposed at the bottom of the hood body.

42. The preventive maintenance system of claim 33, the preventive maintenance hood further comprising a pair of handles disposed on the hood body.
